(19) United States
(12) Patent Application Publication
(10) Pub. No.: US 2024/0113605 A1
(43) Pub. Date: Apr. 4, 2024

(54) ROTOR MANUFACTURING METHOD AND ROTOR MANUFACTURING APPARATUS

(71) Applicant: HONDA MOTOR CO., LTD., Tokyo (JP)

(72) Inventors: Yuki Abe, Wako-shi, Saitama (JP); Yuki Hasegawa, Wako-shi, Saitama (JP); Masatoshi Nagashima, Wako-shi, Saitama (JP)

(21) Appl. No.: 18/372,190

(22) Filed: Sep. 25, 2023

(30) Foreign Application Priority Data
Sep. 30, 2022 (JP) 2022-157303

(51) Int. Cl. H02K 15/03; B23P 11/02; H02K 1/28

(52) U.S. Cl. CPC H02K 15/03; B23P 11/022; H02K 1/28

(57) ABSTRACT

A method for manufacturing a rotor including a rotor body, and a sleeve surrounding an outer peripheral portion of the rotor body and applying a pressurizing force toward an inner periphery to the rotor body, includes: preparing the sleeve having a tubular shape and having an inner diameter smaller than an outer diameter of the rotor body; expanding an inner diameter of the sleeve to be larger than an outer diameter of the rotor body, by applying a liquid pressure to an inner diameter portion of the sleeve; inserting the rotor body into the inner diameter portion of the sleeve while applying the liquid pressure; and fixing the sleeve to the rotor body by removing the liquid pressure and contracting the sleeve.

### CROSS-REFERENCE TO RELATED APPLICATIONS

This application is based upon and claims the benefit of priority from Japanese Patent Application No. 2022-157303 filed on Sep. 30, 2022, the contents of which are incorporated herein by reference.

### BACKGROUND OF THE INVENTION

### Field of the Invention

The present invention relates to a rotor manufacturing method and a rotor manufacturing apparatus for a rotary electric machine.

### Description of the Related Art

As one approach for reducing the size and weight of a rotary electric machine, there is an increase in rotation speed. However, when the rotation speed of the rotary electric machine is increased, a large centrifugal force acts on the rotor. As such, a technique has been proposed in which a sleeve is disposed on an outer peripheral portion of a rotor body to reinforce the rotor.

For example, JP 7049285 B2 discloses a technique in which a sleeve is disposed so as to surround outer peripheral surfaces of a rotor body and a magnet, and a gap between the sleeve and the magnet is filled with a solidified resin to prevent the magnet from floating due to a centrifugal force.

Further, as other methods for attaching the sleeve to the outer peripheral portion of the rotor body, there have been proposed methods of shrink fitting, cooling fitting, and press fitting.

### SUMMARY OF THE INVENTION

From the viewpoint of the reinforcing effect against the centrifugal force, the sleeve is required to be attached to the rotor body so as to exert a sufficient tightening force (also referred to as a pressurizing force) on the rotor body. Further, from the viewpoint of reducing the magnetic gap, the sleeve is required to be thin. However, in the related art, there is a problem that it is difficult to achieve both the pressurization force and the thinness of the sleeve because of limitations in the manufacturing process.

That is, it is difficult for the sleeve attached by the shrink fitting and the cooling fitting to obtain a sufficient pressurizing force due to the restriction of the thermal expansion coefficient, and the high rotation speed of the rotary electric machine is restricted. In addition, the sleeve attached by press fitting needs to be thick enough to prevent buckling or deformation at the time of press fitting, resulting in an increase in the size of the rotary electric machine due to an increase in the magnetic gap.

In the technique of JP 7049285 B2, the pressurizing force can be secured by press-fitting the resin, but it is necessary to dispose a resin layer between the sleeve and the rotor body, and there is a possibility that the magnetic gap may be increased.

It is an object of the present invention to solve the above problems.

According to an aspect of the present disclosure, there is provided a method for manufacturing a rotor including a rotor body, and a sleeve configured to surround an outer peripheral portion of the rotor body and apply a pressurizing force toward an inner periphery to the rotor body, the method including: a step of preparing the sleeve having a tubular shape and having an inner diameter smaller than an outer diameter of the rotor body; an expansion step of expanding the inner diameter of the sleeve to be larger than the outer diameter of the rotor body, by applying a liquid pressure to an inner diameter portion of the sleeve; an insertion step of inserting the rotor body into the inner diameter portion of the sleeve while applying the liquid pressure; and a fixing step of fixing the sleeve to the rotor body by removing the liquid pressure and contracting the sleeve.

According to another aspect of the present invention, there is provided a rotor manufacturing apparatus for attaching a sleeve to an outer peripheral portion of a rotor body, the rotor manufacturing apparatus including: a support block configured to abut against a lower end portion of the sleeve to close a lower end side of an inner diameter portion of the sleeve; a cylinder member including: a tubular portion configured to abut against an upper end portion of the sleeve; and a cylinder hole that is formed inside the tubular portion so as to communicate with the inner diameter portion of the sleeve and is configured to accommodate the rotor body; a piston configured to slide in the cylinder hole and push out the rotor body toward the sleeve; and a liquid supply unit configured to fill the cylinder hole and the inner diameter portion with liquid, wherein the piston sends the liquid in the cylinder hole into the inner diameter portion to apply a liquid pressure to an inside of the sleeve.

With the rotor manufacturing method and the rotor manufacturing apparatus according to the above-described aspects, a thin sleeve can be attached to the outer peripheral portion of the rotor body in a manner so as to generate a high pressurizing force. Therefore, the rotor manufacturing method and the rotor manufacturing apparatus according to the above aspects can provide a rotor suitable for downsizing and high-speed rotation of a rotary electric machine.

The above and other objects, features, and advantages of the present invention will become more apparent from the following description when taken in conjunction with the accompanying drawings, in which preferred embodiments of the present invention is shown by way of illustrative example.

### BRIEF DESCRIPTION OF THE DRAWINGS

FIG. 1 is an explanatory view of a rotor manufacturing apparatus according to a first embodiment;

FIG. 2A is an explanatory diagram of steps up to a liquid introduction step in a rotor manufacturing method according to the first embodiment;

FIG. 2B is an explanatory view of an expansion step;

FIG. 3A is an explanatory view of an insertion step in the rotor manufacturing method according to the first embodiment;

FIG. 3B is an explanatory view of a fixing step;

FIG. 4 is an explanatory view of a step of attaching a second layer sleeve in a second embodiment;

FIG. 5A is a cross-sectional view showing a stress distribution of the sleeve attached by the rotor manufacturing method according to the first embodiment;

FIG. 5B is a cross-sectional view showing the stress distribution in a three layer sleeve attached by the rotor manufacturing method of the second embodiment;

FIG. 6 is a graph showing the obtained relationship between the thickness of the sleeve and the rotation speed at which the permanent magnet levitates, for a sleeve attached by press-fitting (comparative example), a sleeve of 1 layer (first embodiment), a sleeve of 2 layers (second embodiment), and a sleeve of 3 layers (second embodiment);

FIG. 7A is a cross-sectional view illustrating a problem in a case where a rotor body is long; and

FIG. 7B is a cross-sectional view showing a rotor manufacturing method of according to a third embodiment.

### DETAILED DESCRIPTION OF THE INVENTION

### First Embodiment

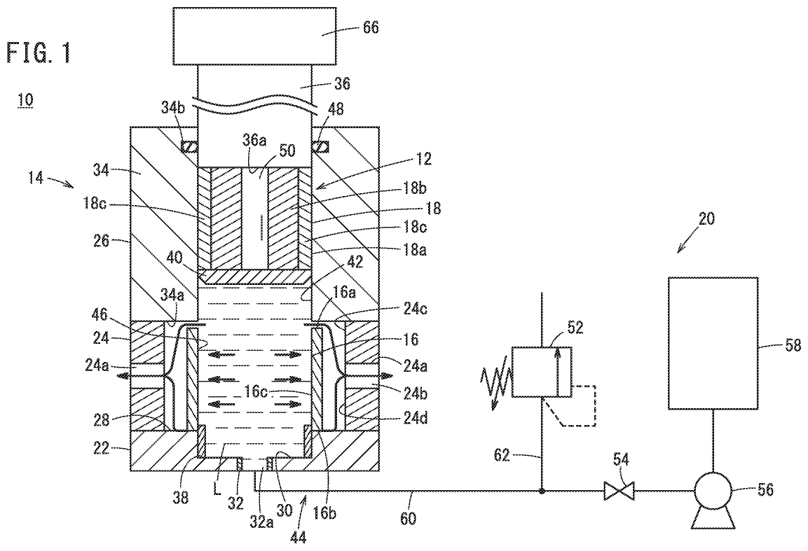

As shown in FIG. 1, in a manufacturing apparatus 10 for a rotor 12 (rotor manufacturing apparatus) according to the present embodiment, a sleeve 16 is attached to a rotor body 18 by a cylinder jig 14.

The rotor body 18 includes a rotor core 18b made of a magnetic material and a permanent magnet 18c attached to the rotor core 18b. The rotor body 18 has a cylindrical shape. The sleeve 16 is a cylindrical member made of a fiber-reinforced resin material and is attached to an outer peripheral portion 18a of the rotor body 18 to prevent the permanent magnet 18c from floating due to centrifugal force. The sleeve 16 is formed of, for example, carbon fiber reinforced plastic (CFRP). The sleeve 16 can be constituted by only a hoop layer in which reinforcing fibers are wound in the circumferential direction. The sleeve 16 constituted by only the hoop layer is preferable because the performance of the reinforcing fiber is most efficiently exhibited and the thickness of the sleeve 16 can be reduced. The sleeve 16 has an inner diameter smaller than the diameter (outer diameter) of the rotor body 18 in order to apply a tightening load to the rotor body 18 when the sleeve 16 is attached to the outer peripheral portion 18a of the rotor body 18.

As shown in the drawing, the manufacturing apparatus 10 for the rotor 12 includes a cylinder jig 14 and a liquid supply unit 20. The cylinder jig 14 is a jig that holds the rotor body 18 and the sleeve 16 and attaches the sleeve 16 to the rotor body 18. The liquid supply unit 20 supplies liquid L to the cylinder jig 14.

The cylinder jig 14 includes a support block 22, a coupling portion 24, and a cylinder member 26. The support block 22 is positioned at a lower portion of the cylinder jig 14. The support block 22 has a supporting surface 28 for supporting the sleeve 16, a recessed portion 30 that is recessed downward from the supporting surface 28, and a port portion 32 that opens to the recessed portion 30.

The supporting surface 28 has a smooth flat surface, and abuts against a lower end portion 16b of the sleeve 16. The supporting surface 28 supports the lower end portion 16b of the sleeve 16 slidably in the in-plane direction of the supporting surface 28, and allows deformation due to expansion of the sleeve 16. The lower end portion 16b of the sleeve 16 is constituted by a smooth surface, and a portion, of the lower end portion 16b, that lies on the outer peripheral side in the circumferential direction of the sleeve 16 abuts against the supporting surface 28. There is no seal structure between the lower end portion 16b of the sleeve 16 and the supporting surface 28, and there is a minute gap that allows the liquid L to leak little by little. As long as deformation of the sleeve 16 is allowed, application of a seal structure that suppresses leakage of the liquid L is not excluded.

The recessed portion 30 is circular in a plan view and has a predetermined depth in the height direction. The recessed portion 30 has a diameter and a depth capable of accommodating a head member 40 attached to the tip of the rotor body 18. The recessed portion 30 has a positioning member 38 projecting toward the sleeve 16 and positioning the sleeve 16 concentrically with the cylinder member 26 by abutting on an inner peripheral surface 16c of the sleeve 16. The positioning member 38 abuts against the sleeve 16 from the inner peripheral side of the sleeve 16 so as not to hinder the expansion of the sleeve 16. The positioning member 38 includes an elastic member, and is detached from the sleeve 16 and housed in the recessed portion 30 when being pushed by the head member 40.

The port portion 32 is formed at the center of the recessed portion 30 and opens to the bottom of the recessed portion 30. The port portion 32 has a port flow path 32a penetrating the support block 22 in the up-down direction. The lower end of the port flow path 32a is connected to a liquid flow path 44. The port flow path 32a is connected to the liquid supply unit 20 via the liquid flow path 44.

The coupling portion 24 is located on the support block 22 and connects the support block 22 and the cylinder member 26. The coupling portion 24 has a cylindrical shape concentric with the cylinder member 26, and has an accommodation chamber 24c for accommodating the sleeve 16 therein. The accommodation chamber 24c has a larger inner diameter than the cylinder member 26 and the sleeve 16, and forms, around the sleeve 16, a clearance gap 24d in which the sleeve 16 can expand. The height of the accommodation chamber 24c may be the same as the height of the sleeve 16. In addition, the accommodation chamber 24c accommodates the liquid L leaking from the end portions of the sleeve 16. The coupling portion 24 has a plurality of discharge ports 24a on a side portion thereof. Each of the discharge ports 24a has a discharge flow path 24b penetrating the coupling portion 24 in the radial direction. The discharge port 24a discharges the liquid L in the accommodation chamber 24c to the outside.

In the illustrated example, the coupling portion 24 is configured as a member separate from the support block 22 and the cylinder member 26. However, the present embodiment is not limited thereto, and the coupling portion 24 may be integrally formed with the support block 22 or the cylinder member 26.

The cylinder member 26 includes a main body 34, a piston 36, and a head member 40. The main body 34 has a contact surface 34a and a cylinder hole 42. The contact surface 34a is located at a lower portion of the main body 34. The contact surface 34a is in contact with an upper end portion 16a of the sleeve 16. The contact surface 34a is a smooth flat surface extending in a direction perpendicular to the axis, and comes into contact with the upper end portion 16a of the sleeve 16. Since the inner peripheral portion of the sleeve 16 before the liquid pressure is applied has an inner diameter smaller than that of the rotor body 18, the inner peripheral portion of the sleeve 16 is located inward of the cylinder hole 42. Therefore, the contact surface 34a before the liquid pressure is applied comes into contact with a portion, of the upper end portion 16a of the sleeve 16, that lies on the outer peripheral side. Note that a gap having a predetermined width may be formed between the upper end portion 16a of the sleeve 16 and the contact surface 34a, and the contact surface 34a and the upper end portion 16a may not necessarily be in contact with each other.

The upper end portion 16a of the sleeve 16 can slide on the contact surface 34a. Due to the expansion of the sleeve 16, the upper end portion 16a of the sleeve 16 slides toward the outer periphery of the contact surface 34a. The upper end portion 16a of the sleeve 16 and the contact surface 34a of the cylinder member 26 have a clearance gap through which the liquid L can leak little by little.

The main body 34 has a cylindrical shape and includes a cylinder hole 42. The cylinder hole 42 is a hole having a circular cross section with an inner diameter slightly larger than that of the rotor body 18, and extends through the main body 34 in the up-down direction. A clearance is formed between the cylinder hole 42 and the rotor body 18. The cylinder hole 42 has a length capable of accommodating the rotor body 18 and a part of the piston 36 in the up-down direction (axial direction). A packing receiving groove 34b extending in the circumferential direction of the cylinder hole 42 is formed at a predetermined portion of the cylinder hole 42, and a packing 48 such as an O-ring is received in the packing receiving groove 34b. The packing 48 is in liquid-tight contact with the piston 36 and prevents the liquid L from flowing out through a gap between the piston 36 and the cylinder hole 42.

The piston 36 is accommodated in the cylinder hole 42. The piston 36 is moved in the axial direction by a pressing device 66 or the like. The piston 36 moves in the up-down direction along the cylinder hole 42 while sliding in the cylinder hole 42. The piston 36 holds the rotor body 18 at the lower end portion 36a. The piston 36 has a downwardly projecting support rod 50 which positions the rotor body 18 on the central axis of the piston 36. The support rod 50 is inserted through a through hole of the rotor body 18. The number and arrangement positions of the support rods 50 are not limited to the illustrated example.

The head member 40 is connected to a distal end of the support rod 50. The head member 40 sandwiches and holds the rotor body 18 between the head member 40 and the piston 36. The head member 40 has the same diameter as the rotor body 18. The head member 40 is disconnected from the support rod 50 after the rotor body 18 has been inserted into an inner diameter portion 46 of the sleeve 16. When the connection between the head member 40 and the support rod 50 is released, the rotor body 18 and the sleeve 16 can be removed from the piston 36.

The liquid supply unit 20 is connected to the port portion 32 via the liquid flow path 44. The liquid supply unit 20 includes a relief valve 52, a shutoff valve 54, a pump 56, and a storage tank 58. The liquid flow path 44 includes a first flow path 60 connecting the storage tank 58 and the port portion 32, and a second flow path 62 branching from the first flow path 60 and connected to the relief valve 52.

The relief valve 52 is connected to the port portion 32 via the second flow path 62 and the first flow path 60 (the liquid flow path 44). The relief valve 52 discharges the liquid L when the liquid pressure exceeds a predetermined value (for example, 70 MPa). The relief valve 52 keeps the liquid pressure applied to the sleeve 16, below a range equal to or less than a predetermined value.

The storage tank 58 is connected to the port portion 32 via the first flow path 60. The storage tank 58 contains the liquid L that is introduced into the inner diameter portion 46 of the sleeve 16. In the present embodiment, for example, silicone oil, grease, hydraulic oil, or the like can be used as the liquid L. The liquid L is not particularly limited to the examples described above, but is preferably a liquid L having a high viscosity and a small decrease in kinematic viscosity due to shear force, and silicone oil can be suitably used.

The shutoff valve 54 and the pump 56 are disposed in the middle of the first flow path 60 connecting the storage tank 58 and the port portion 32. The shutoff valve 54 is disposed in the first flow path 60 at a position closer to the storage tank 58 than the branch point to the second flow path 62. The shutoff valve 54 closes the first flow path 60 to prevent propagation of the liquid pressure to the pump 56 and the storage tank 58.

The pump 56 is disposed between the storage tank 58 and the shutoff valve 54. The pump 56 pumps out the liquid L in the storage tank 58 to the port portion 32.

The manufacturing apparatus 10 for the rotor 12 according to the present embodiment is configured as described above. Hereinafter, a method for manufacturing the rotor 12 (rotor manufacturing method) using the manufacturing apparatus 10 for the rotor 12 will be described.

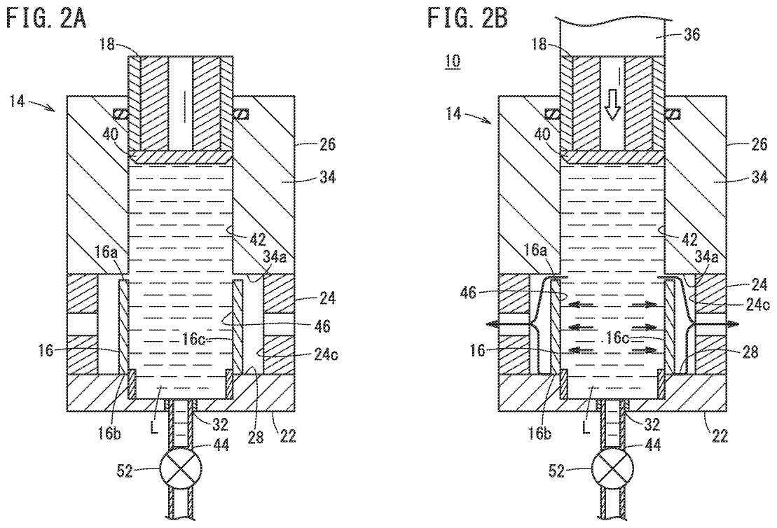

First, the sleeve 16 is prepared. The sleeve 16 has an inner diameter that is smaller than the outer diameter of the rotor body 18. Thereafter, as shown in FIG. 2A, the sleeve 16 is disposed on the accommodation chamber 24c. The lower end portion 16b of the sleeve 16 abuts against the supporting surface 28 of the support block 22, and the upper end portion 16a of the sleeve 16 abuts against the contact surface 34a of the main body 34 of the cylinder member 26. Although, in FIG. 2A, the minute clearance (gap) formed between the sleeve 16 and the contact surface 34a is illustrated in an exaggerated manner, the embodiment is not limited to this. The sleeve 16 may be brought into contact with the contact surface 34a without any clearance (gap) in visual observation. The inner diameter portion 46 of the sleeve 16 is disposed coaxially with the cylinder hole 42.

Next, the liquid L is introduced into the inner diameter portion 46 of the sleeve 16 through the port portion 32 as shown in the drawing. The liquid L is supplied via the storage tank 58 and the pump 56 of FIG. 1. As shown in FIG. 2A, the introduction of the liquid L is continued until the cylinder hole 42 on the lower side of the head member 40 is filled with the liquid L. When the introduction of the liquid L is completed, the pump 56 of FIG. 1 is stopped, and the shutoff valve 54 closes the first flow path 60.

Next, as shown in FIG. 2B, the piston 36 is pushed down by the pressing device 66 or the like and starts to move downward. With the downward movement of the piston 36, the liquid L in the cylinder hole 42 flows toward the inside of the sleeve 16. A part of the liquid L flows out from the gap between the upper end portion 16a of the sleeve 16 and the cylinder member 26 (contact surface 34a) and the gap between the lower end portion 16b of the sleeve 16 and the support block 22 (supporting surface 28). Since the flow rate of the liquid L flowing into the inside of the sleeve 16 by the action of the piston 36 is larger than the flow rate of the liquid L flowing out from the sleeve 16, the liquid pressure in the inner diameter portion 46 of the sleeve 16 increases.

As the liquid pressure increases, the flow rate of the liquid L flowing out of the inner diameter portion 46 of the sleeve 16 increases. The flow rate of the liquid L flowing into the sleeve 16 and the flow rate of the fluid flowing out of the sleeve 16 by the action of the piston 36 are balanced, and a predetermined liquid pressure (for example, 30 MPa) is applied to the sleeve 16. The application of liquid pressure causes the sleeve 16 to expand. As a result, the inner diameter of the sleeve 16 becomes larger than the outer diameter of the rotor body 18.

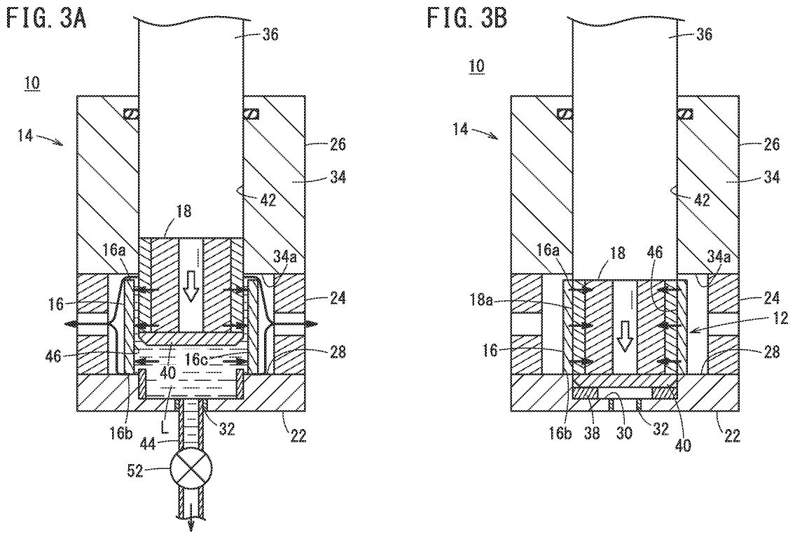

As shown in FIG. 3A, the piston 36 is further lowered, and an insertion step is performed in which the rotor body 18 is inserted into the inner diameter portion 46 of the sleeve 16. Since the inner diameter of the sleeve 16 is larger than the outer diameter of the rotor body 18, the rotor body 18 can move along the inner diameter portion 46 of the sleeve 16 without contacting the sleeve 16. A part of the liquid L positioned on the lower side of the head member 40 flows through the gap between the rotor body 18 and the inner peripheral surface 16c of the sleeve 16 and flows out to the outside of the sleeve 16. In the latter half of the insertion step, the path length of the gap between the rotor body 18 and the inner peripheral surface 16c of the sleeve 16 increases, and accordingly it becomes difficult for the liquid L to flow out, so that the liquid pressure inside the sleeve 16 increases.

In the latter half of the insertion step, when the liquid pressure inside the sleeve 16 exceeds a predetermined pressure, the relief valve 52 (see FIG. 1) opens. The relief valve 52 keeps the liquid pressure inside the sleeve 16 at a predetermined value by discharging the liquid L inside the sleeve 16. The relief valve 52 prevents excessive liquid pressure from occurring in the inner diameter portion 46 of the sleeve 16 to prevent damage to the sleeve 16.

As shown in FIG. 3B, when the rotor body 18 is fully inserted into the inner diameter portion 46 of the sleeve 16, the head member 40 abuts against the bottom of the recessed portion 30 to stop the downward movement of the piston 36. Thereafter, the inflow of the liquid L into the interior of the sleeve 16 is stopped, and the liquid pressure in the inner diameter portion 46 of the sleeve 16 decreases. The reduction in liquid pressure in the inner diameter portion 46 of the sleeve 16 causes the sleeve 16 to contract. As a result, the sleeve 16 is fixed to the outer peripheral portion 18a of the rotor body 18. The sleeve 16 is fixed to the outer peripheral portion 18a of the rotor body 18 while applying a pressurizing force according to the difference between the inner diameter of the sleeve 16 in the initial state and the outer diameter of the rotor body 18 to the rotor body 18.

As described above, the method for manufacturing the rotor 12 of the present embodiment is a novel liquid-pressure expansion press-fitting method, and the rotor body 18 can be inserted into the sleeve 16 by expanding the sleeve 16 by liquid pressure, without coming into contact with the sleeve 16. Therefore, the method for manufacturing the rotor 12 can prevent buckling and deformation even if the sleeve 16 is thin. In addition, according to the method for manufacturing the rotor 12, the thin sleeve 16 can be attached to the outer peripheral portion 18a of the rotor body 18 in a manner so as to generate a high pressurizing force.

### Second Embodiment

In the present embodiment, a method for attaching a sleeve 16A having a multilayer structure to an outer peripheral portion 18a of the rotor body 18 will be described. The manufacturing apparatus 10 for the rotor 12 used in the present embodiment is the same as the manufacturing apparatus 10 described with reference to FIG. 1. In the present embodiment, the description of the manufacturing apparatus 10 for the rotor 12 is omitted.

The present embodiment includes a mode in which the sleeve 16A having a multilayer structure of two layers, three layers, or more layers is attached to the outer peripheral portion 18a of the rotor body 18. Each of a first sleeve 161 and a second sleeve 162 constituting the sleeve 16A is thinner than the sleeve 16 of the first embodiment. When a sleeve 16A having a two-layer structure is attached to the rotor body 18 instead of the single-layer sleeve 16 (the first embodiment), the thicknesses of the first sleeve 161 on the inner peripheral side and the second sleeve 162 on the outer peripheral side can be set to half of the thickness of the single-layer sleeve 16. That is, when the single-layer sleeve 16 (first embodiment) has a thickness of, for example, 3 mm, the thicknesses of the first sleeve 161 and the second sleeve 162 of the two-layer sleeve 16 may be 1.5 mm. In the sleeve 16A having a three-layer structure, the thicknesses of the first sleeve 161, the second sleeve 162, and a third sleeve 163 may set to be one third of that of the sleeve 16 having the single-layer structure.

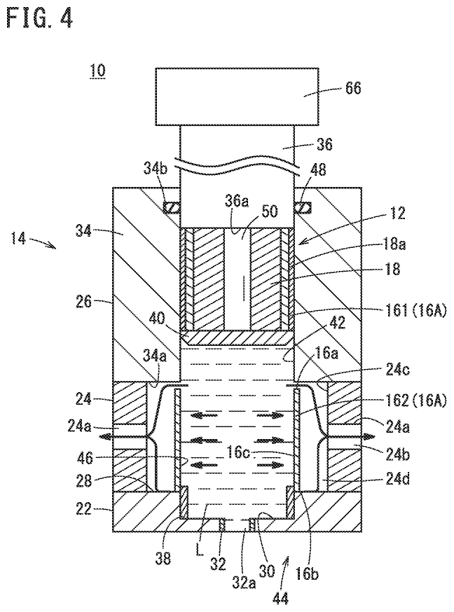

FIG. 4 shows an example in which the second sleeve 162 is attached to the outer circumferential surface of the first sleeve 161. The first sleeve 161 is attached to the outer peripheral portion 18a of the rotor body 18 by the method described with reference to the FIGS. 2A to 3B.

The second sleeve 162 has an inner diameter smaller than the outer diameter of the first sleeve 161 attached to the rotor body 18. The value of the inner diameter of the second sleeve 162 is set so as to generate a pressurizing force equivalent to the pressurizing force of the first sleeve 161. The second sleeve 162 is disposed in the accommodation chamber 24c. The first sleeve 161 and the rotor body 18 are accommodated in the cylinder member 26. Thereafter, a liquid introduction step of introducing the liquid L into the inner diameter portion 46 of the second sleeve 162 and the cylinder hole 42 of the cylinder member 26 is performed.

Next, the piston 36 is then pushed downward. As a result, liquid pressure is applied to the inner diameter portion 46 of the second sleeve 162 to expand the second sleeve 162, as shown in the drawing. Thereafter, the first sleeve 161 and the rotor body 18 are inserted into the inner diameter portion 46 of the expanded second sleeve 162. Thereafter, the liquid pressure is removed and the second sleeve 162 contracts, so that the second sleeve 162 is fixed to the outer circumferential surface of the first sleeve 161.

With the above steps, the attachment of the second sleeve 162 to the outer peripheral portion 18a of the rotor body 18 is completed. When the third sleeve 163, which is the third layer, is attached, the steps described with reference to FIG. 4 may be repeated for the rotor body 18 to which the second sleeve 162 has been attached. Since the first sleeve 161, the second sleeve 162, and the third sleeve 163 attached as described above are attached to the rotor body 18 in a state of being expanded by liquid pressure, the press-fit surfaces do not slide with other members. Therefore, a material having a low surface hardness can be selected as a material constituting the first sleeve 161, the second sleeve 162, and the third sleeve 163. Conventionally, since the members of the same material slide while contacting each other, there is a possibility that the insides of the sleeve 16A of the plurality of layers are scratched. On the other hand, in the method for manufacturing the rotor 12 according to the present embodiment, the first sleeve 161, the second sleeve 162, and the third sleeve 163 can be attached to the outer peripheral portion of the rotor body 18 without sliding in abutment with each other.

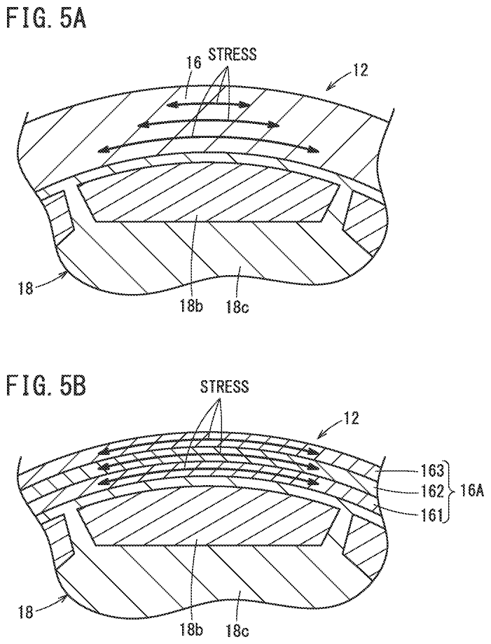

As shown in FIG. 5A, in the sleeve 16 having the single-layer structure, the stress distribution is such that the internal stress (tension) increases toward the inner peripheral side in the sleeve 16.

On the other hand, as shown in FIG. 5B, in the sleeve 16A having a plurality of layers in the present embodiment, by setting an appropriate inner diameter (interference) in each layer, it is possible to generate uniform stress in each layer.

The sleeve 16A having the multi-layer structure can fully utilize the properties of the reinforcing fibers in each layer. Therefore, as compared with the sleeve 16 having only one layer, the multi-layered sleeve 16A whose thickness is the same as the single-layer structure can generate a larger pressurizing force and can prevent the permanent magnet 18c from floating, also at a higher rotation speed. In addition, for achieving a given pressurizing force, the thickness of the sleeve 16A having the multi-layer structure can be smaller than that of the sleeve 16 having the single-layer structure, and the magnetic gap of the rotary electric machine can be made smaller.

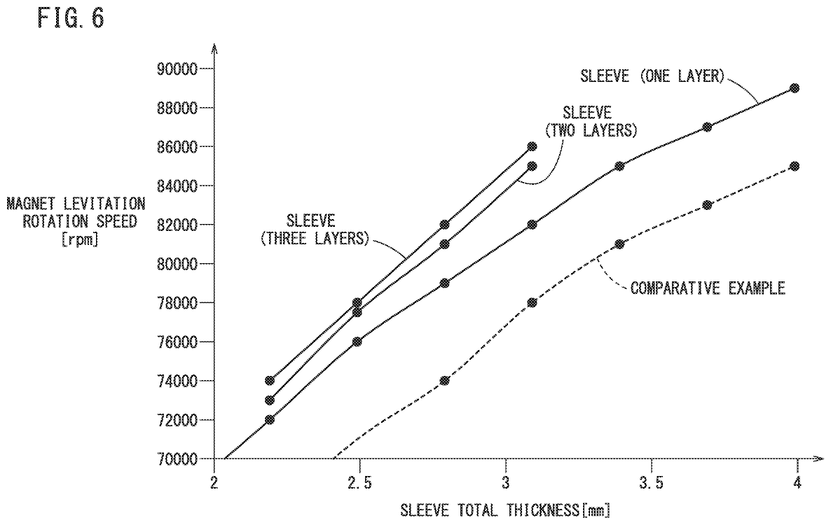

FIG. 6 shows the calculated relationship between the thickness of the sleeve and the magnet levitation rotation speed, for a sleeve of a comparative example, a sleeve 16 of the first embodiment, and sleeves 16A of the second embodiment (two-layer and three-layer structures). The comparative example is a sleeve attached by press-fitting. The sleeve of the comparative example is divided into a plurality of blocks in the axial direction in order to avoid buckling due to press-fitting, and includes a reinforcing layer for reinforcing the strength in the axial direction. On the other hand, the sleeves 16 and 16A of the first embodiment and the second embodiment are constituted by only the hoop layer.

As shown in the drawing, when a comparison is made under the condition that the thicknesses of the entire sleeve is set to a predetermined value (for example, 3 mm), the sleeves 16 and 16A of the first embodiment and the second embodiment constituted by only the hoop layer can generate a higher pressurizing force than the sleeve of the comparative example. Thus, the levitation of the permanent magnet 18c can be suppressed in a wider range of rotation speed including a higher rotation speed. Further, the sleeve 16A can suppress the levitation of the permanent magnet 18c at up to a higher rotation speed as the number of stacked layers increases.

When the levitation rotation speed of the permanent magnet 18c is to be set to a predetermined value, it can be seen that the sleeves 16 and 16A of the first embodiment and the second embodiment constituted only by the hoop layer can be made thinner than the sleeve of the comparative example. In addition, the sleeve 16A can be made thinner as the number of layers increases.

### Third Embodiment

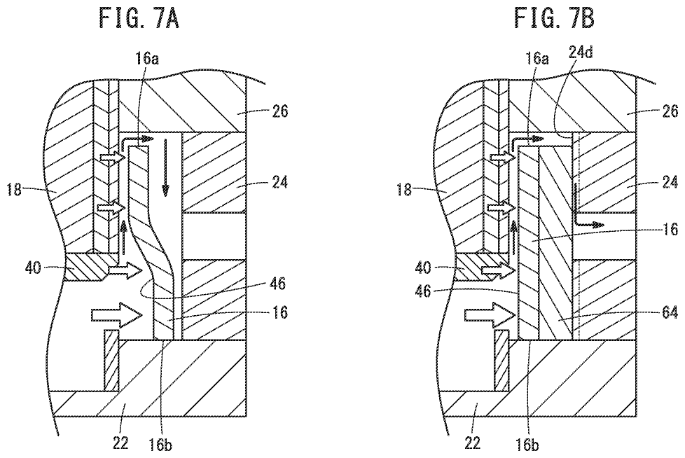

In this embodiment, an aspect suitable for a case where the rotor body 18 is long in the axial direction will be described. As shown in FIG. 7A, when the rotor body 18 is long in the axial direction, the difference in liquid pressure between in the vicinity of the upper end portion 16a of the sleeve 16 and in the vicinity of the lower end thereof becomes larger. As shown in the drawing, in the case of the long rotor body 18 and the long sleeve 16, a pressure drop is likely to occur in the upper portion during the insertion of the rotor body 18. That is, in the case of the long rotor body 18 and the long sleeve 16, the flow rate of the liquid L flowing through the gap between the sleeve 16 and the rotor body 18 decreases. As a result, the liquid pressure decreases in the vicinity of the upper end portion 16a of the sleeve 16. In order to apply a sufficient liquid pressure to the vicinity of the upper end portion 16a of the sleeve 16, a large liquid pressure is required to be applied to the lower end portion 16b of the sleeve 16. However, when an excessive liquid pressure is applied to the lower end portion 16b of the sleeve 16, the sleeve 16 is excessively expanded and broken.

As shown in FIG. 7B, the method for manufacturing the rotor 12 according to the present embodiment includes a step of disposing a deformation prevention ring 64 on the outer periphery of the sleeve 16 when there is a possibility that an excessive liquid pressure is applied to the sleeve 16. The deformation prevention ring 64 is disposed in the clearance gap 24d between the outer periphery of the sleeve 16 and the inside wall of the accommodation chamber 24c. When the sleeve 16 expands beyond a predetermined diameter, the deformation prevention ring 64 comes into contact with the outer peripheral surface of the sleeve 16 to prevent the sleeve 16 from expanding outward. Therefore, the deformation prevention ring 64 makes it possible to apply a large liquid pressure to the inner diameter portion 46 of the sleeve 16.

As described above, the method for manufacturing the rotor 12 according to the present embodiment enables the long sleeve 16 to be attached to the long rotor body 18. The manufacturing apparatus 10 of the first embodiment may include the deformation prevention ring 64 instead of the relief valve 52. Even in this case, the manufacturing apparatus 10 can prevent the sleeve 16 from being damaged by the liquid pressure.

The above disclosure is summarized as follows.

An aspect of the present invention is characterized by the method for manufacturing the rotor 12 including the rotor body 18, and the sleeve 16, 16A surrounding the outer peripheral portion 18a of the rotor body and applying a pressurizing force toward the inner periphery to the rotor body, the method including: the step of preparing the sleeve having a tubular shape and having an inner diameter smaller than an outer diameter of the rotor body; the expansion step of expanding the inner diameter of the sleeve to be larger than the outer diameter of the rotor body, by applying a liquid pressure to the inner diameter portion (46) of the sleeve; the insertion step of inserting the rotor body into the inner diameter portion of the sleeve while applying the liquid pressure; and the fixing step of fixing the sleeve to the rotor body by removing the liquid pressure and contracting the sleeve.

With the above-described method for manufacturing the rotor, the rotor body is inserted into the sleeve in a state where the sleeve is expanded by applying the liquid pressure to the sleeve. Thus, the rotor body can be inserted into the sleeve without contacting the sleeve. Therefore, in the rotor manufacturing method, a thin sleeve can be fixed so as to apply a high pressurizing force to the outer peripheral portion of the rotor body without buckling or deforming of the thin sleeve.

In the above-described method for manufacturing the rotor, the expansion step may include: the step of connecting the support block 22 that closes the lower end of the inner diameter portion of the sleeve, to the lower end portion 16b of the sleeve; the step of connecting the cylinder member 26 to the upper end portion 16a of the sleeve, the cylinder member including the cylinder hole 42 that communicates with the inner diameter portion and the rotor body being accommodated in the cylinder hole; and the liquid introduction step of introducing liquid L in the cylinder hole into the inner diameter portion of the sleeve by moving the rotor body toward the sleeve. With this rotor manufacturing method, liquid pressure can be applied to the sleeve by the movement of the liquid from the cylinder hole accompanying the movement of the rotor member to the sleeve.

In the above method for manufacturing the rotor, in the liquid introduction step, the liquid may be introduced in an amount larger than a leakage amount of the liquid leaking from the upper end portion and the lower end portion of the sleeve. With this method for manufacturing the rotor, since the liquid pressure can be applied to the sleeve without providing a seal structure in the gap of the sleeve, a complicated seal structure is not required, and the configuration of the manufacturing apparatus 10 can be simplified.

In the above-described method for manufacturing the rotor, the liquid introduction step may be performed by moving the rotor body toward the sleeve in a state where the inner diameter portion of the sleeve and the cylinder hole of the cylinder member are filled with the liquid. With this rotor manufacturing method, pressurization by a high pressure pump or the like is not required, and a sufficient liquid pressure can be applied to the inner diameter portion of the sleeve merely by pushing down the piston and the rotor body by the pressing device 66.

The above method for manufacturing the rotor may further include: the step of preparing the second sleeve 162 having an inner diameter smaller than an outer diameter of the sleeve 161 fixed to the rotor body; and the step of fixing the second sleeve to an outer peripheral surface of the sleeve fixed to the rotor body, by performing the expansion step, the insertion step, and the fixing step on the second sleeve. With this rotor manufacturing method, a sleeve having a plurality of layers can be formed on the outer peripheral portion of the rotor body.

Another aspect of the present invention is characterized by the rotor manufacturing apparatus 10 for attaching the sleeve to the outer peripheral portion of the rotor body, the rotor manufacturing apparatus including: the support block configured to abut against the lower end portion of the sleeve to close the lower end side of the inner diameter portion of the sleeve; the cylinder member 26 including: the tubular portion configured to abut against the upper end portion of the sleeve; and the cylinder hole that is formed inside the tubular portion so as to communicate with the inner diameter portion of the sleeve and is configured to accommodate the rotor body; the piston 36 configured to slide in the cylinder hole and push out the rotor body toward the sleeve; and the liquid supply unit 20 configured to fill the cylinder hole and the inner diameter portion with liquid, wherein the piston sends the liquid in the cylinder hole into the inner diameter portion to apply a liquid pressure to the inside of the sleeve. With this rotor manufacturing apparatus, the rotor body can be inserted into the inner diameter portion of the sleeve in a non-contact manner, by applying liquid pressure to the sleeve and expanding the sleeve by the movement of the rotor body of the cylinder member. Therefore, with the rotor manufacturing apparatus, a thin sleeve can be fixed to the outer peripheral portion of the rotor body in a manner so as to generate a high pressurizing force.

In the above rotor manufacturing apparatus, the support block may abut against the lower end portion of the sleeve while allowing the lower end portion to expand in the radial direction of the sleeve, and the cylinder member may abut against the upper end portion of the sleeve while allowing the upper end portion to expand in the radial direction. With this rotor manufacturing apparatus, since the seal structure is not provided at the upper end portion or the lower end portion of the sleeve, the upper end portion and the lower end portion of the sleeve can be allowed to expand, and the rotor body can be inserted into the sleeve without coming into contact with the sleeve.

In the above rotor manufacturing apparatus, the piston may move the rotor body toward the inner diameter portion of the sleeve while leaking the liquid from a gap between the sleeve and the support block and a gap between the sleeve and the cylinder member, and may insert the rotor body into the inner diameter portion while applying the liquid pressure to the inner diameter portion. This rotor manufacturing apparatus can apply a sufficient liquid pressure to the inside of the sleeve by the movement of the piston of the cylinder member without using a high pressure pump.

The above rotor manufacturing apparatus may include the relief valve 52 that communicates with the inner diameter portion of the sleeve and is configured to discharge the liquid present in the inner diameter portion when the liquid pressure in the inner diameter portion exceeds a predetermined value, to thereby keep the liquid pressure in the inner diameter portion at the predetermined value. This rotor manufacturing apparatus can prevent an excessive liquid pressure from being applied to the sleeve in the latter half of the insertion step of the rotor body.

The rotor manufacturing apparatus may further include the deformation prevention ring 64 that surrounds the outer peripheral portion of the sleeve to prevent excessive expansion of the sleeve. This rotor manufacturing apparatus can prevent damage to the sleeve by preventing excessive expansion due to a pressure increase at the lower end portion of the sleeve.

Note that the present invention is not limited to the embodiment described above, and various configurations can be adopted therein without departing from the essence and gist of the present invention.

What is claimed is:

1. A method for manufacturing a rotor including a rotor body and a sleeve configured to surround an outer peripheral portion of the rotor body and apply a pressurizing force toward an inner periphery to the rotor body, the method comprising:
preparing the sleeve having a tubular shape and having an inner diameter smaller than an outer diameter of the rotor body;
expanding the inner diameter of the sleeve to be larger than the outer diameter of the rotor body, by applying a liquid pressure to an inner diameter portion of the sleeve;
inserting the rotor body into the inner diameter portion of the sleeve while applying the liquid pressure; and
fixing the sleeve to the rotor body by removing the liquid pressure and contracting the sleeve.

2. The method for manufacturing the rotor according to claim 1, wherein
the expanding of the inner diameter of the sleeve comprises:
connecting a support block that closes a lower end of the inner diameter portion of the sleeve, to a lower end portion of the sleeve;
connecting a cylinder member to an upper end portion of the sleeve, the cylinder member including a cylinder hole that communicates with the inner diameter portion and the rotor body being accommodated in the cylinder hole; and
introducing liquid in the cylinder hole into the inner diameter portion of the sleeve by moving the rotor body toward the sleeve.

3. The method for manufacturing the rotor according to claim 2, wherein
in the introducing of the liquid, the liquid is introduced in an amount larger than a leakage amount of the liquid leaking from the upper end portion and the lower end portion of the sleeve.

4. The method for manufacturing the rotor according to claim 2, wherein
the introducing of the liquid is performed by moving the rotor body toward the sleeve in a state where the inner diameter portion of the sleeve and the cylinder hole of the cylinder member are filled with the liquid.

5. The method for manufacturing the rotor according to claim 1, further comprising:
preparing a second sleeve having an inner diameter smaller than an outer diameter of the sleeve fixed to the rotor body; and
fixing the second sleeve to an outer peripheral surface of the sleeve fixed to the rotor body, by performing the expanding of the inner diameter of the sleeve, the inserting of the rotor body, and the fixing of the sleeve, on the second sleeve.

6. A rotor manufacturing apparatus for attaching a sleeve to an outer peripheral portion of a rotor body, the rotor manufacturing apparatus comprising:
a support block configured to abut against a lower end portion of the sleeve to close a lower end side of an inner diameter portion of the sleeve;
a cylinder member including: a tubular portion configured to abut against an upper end portion of the sleeve; and a cylinder hole that is formed inside the tubular portion so as to communicate with the inner diameter portion of the sleeve and is configured to accommodate the rotor body;
a piston configured to slide in the cylinder hole and push out the rotor body toward the sleeve; and
a liquid supply unit configured to fill the cylinder hole and the inner diameter portion with liquid,
wherein the piston sends the liquid in the cylinder hole into the inner diameter portion to apply a liquid pressure to an inside of the sleeve.

7. The rotor manufacturing apparatus according to claim 6, wherein
the support block abuts against the lower end portion of the sleeve while allowing the lower end portion to expand in a radial direction of the sleeve, and
the cylinder member abuts against the upper end portion of the sleeve while allowing the upper end portion to expand in the radial direction.

8. The rotor manufacturing apparatus according to claim 7, wherein
the piston moves the rotor body toward the inner diameter portion of the sleeve while leaking the liquid from a gap between the sleeve and the support block and a gap between the sleeve and the cylinder member, and inserts the rotor body into the inner diameter portion while applying the liquid pressure to the inner diameter portion.

9. The rotor manufacturing apparatus according to claim 6, further comprising:
a relief valve that communicates with the inner diameter portion of the sleeve and is configured to discharge the liquid present in the inner diameter portion when the liquid pressure in the inner diameter portion exceeds a predetermined value, to thereby keep the liquid pressure in the inner diameter portion at the predetermined value.

10. The rotor manufacturing apparatus according to claim 6, further comprising a deformation prevention ring configured to surround an outer peripheral portion of the sleeve to prevent excessive expansion of the sleeve.
